(19) United States
(12) Patent Application Publication
(10) Pub. No.: US 2021/0279827 A1
(43) Pub. Date: Sep. 9, 2021

(54) Method for Enabling Employer Compliance with Regulatory Rules

(71) Applicant: J.J. Keller & Associates, Inc., Neenah, WI (US)

(72) Inventors: Kevin Roger Kucksdorf, Hortonville, WI (US); Steven Duane Myers, Lee's Summit, MO (US); Joel Hererra, Appleton, WI (US)

(21) Appl. No.: 16/811,525

(22) Filed: Mar. 6, 2020

(51) Int. Cl. G06Q 50/18; G06F 16/9537; G06F 16/9538; G06F 3/14

(52) U.S. Cl. CPC G06Q 50/18; G06F 3/14; G06F 16/9538; G06F 16/9537

(57) ABSTRACT

A method for enabling employer compliance with regulatory compliance rules pertaining to where and when regulated content is displayed for consumption by employees of the employer.

### BACKGROUND

Under federal, state and/or local regulations, employers need to provide employees with regulated content to be in compliance with such regulations. Areas of regulated content can include employment law, compliance assurance and the like.

With respect to employment in particular, federal, state and local employment laws and regulations require all employers with at least one employee to post at each of its locations, in an area frequented by employees, all applicable, current, and required employment law notices. Failure to keep these notices up to date can result in fines and/or lawsuits. Most often these notices are physical posters that are displayed in breakrooms, lunchrooms, lobbies, or other conspicuous locations that are frequented by employees.

Keeping current with regulatory content posting changes/updates is a time-consuming task for an employer. An employer must rely upon someone ensuring physical posters in all employer locations are updated when needed in order to stay in compliance with laws and regulations. In 2019 alone, there were approximately 45 mandatory state employment poster updates, 50 mandatory local employment poster updates, and again as many minor poster updates. In addition, physical posters need to be protected from being altered or defaced, which can be problematic given the high traffic areas they are usually located in.

### SUMMARY

The invention relates to an employment law content determination and delivery method comprising the steps: of for a given geographic location and time, determining appropriate employment law content that is required to be posted to assure employer compliance with employment regulations at the given geographic location and time; delivering the appropriate employment law content to the employer for electronic viewing by employees of the employer; and keeping a record of the employment law content that was delivered for a given geographic location and time.

The invention also relates to a method for enabling compliance for an employer of regulatory compliance rules pertaining to where and when regulated content is displayed for consumption by employees of the employer, the method including the steps: determining at what geographic locations of an employer regulated content needs to be provided to employees of the employer; determining at what points in time that regulated content needs to be provided to the employees of the employer; determining what regulated content needs to be provided for electronic viewing by the employees of the employer at each of the geographic locations and at each of the time points; and delivering the determined regulated content in electronic format to each geographic location and at each time point for consumption by the employees of the employer to ensure the employer is in compliance with regulatory compliance rules at all determined geographic locations and at all times.

The invention also relates to a method for providing employment law content to a display device at a specific geographic location of an employer for viewing by employees to ensure the employer is in compliance with regulatory employment law requirements, the method including the steps: determining a geographic location of a display device; matching the geographic location of the display device to relevant employment law content; delivering the relevant employment law content to the display device for viewing by employees of an employer to make the employer in compliance with regulatory employment law requirements; and delivering updated employment law content to the display device to ensure that the employer stays in compliance at all times with regulatory employment law requirements.

### BRIEF DESCRIPTION OF THE DRAWINGS

FIG. 1 is a perspective view of a display device of the present invention;

FIG. 2 is a schematic of the architecture of the present invention; and

FIG. 3 is a flowchart of the method of the present invention.

Before any embodiments of the invention are explained in detail, it is to be understood that the invention is not limited in its application to the details of constructions and the arrangement of components set forth in the following description or illustrated in the drawings. The invention is capable of other embodiments and of being practiced or of being carried out in various ways.

### DETAILED DESCRIPTION

The invention enables continual compliance for employers of regulatory compliance rules to ensure that such employers are in and remain in compliance with such rules. For example, one regulatory compliance area involves employment law compliances rules and, more particularly, to the employment law posting requirements for employers. However, the invention can be used with other regulatory compliance areas such safety, OSHA, health, firearms and other such areas. The invention will be explained below with respect to employment law posting rules and notices.

Preferably, the invention is carried out by a third party as a subscription service to employers with one or more employee locations. However, employers can also practice the method to ensure internal compliance with federal, state and/or local laws and regulations.

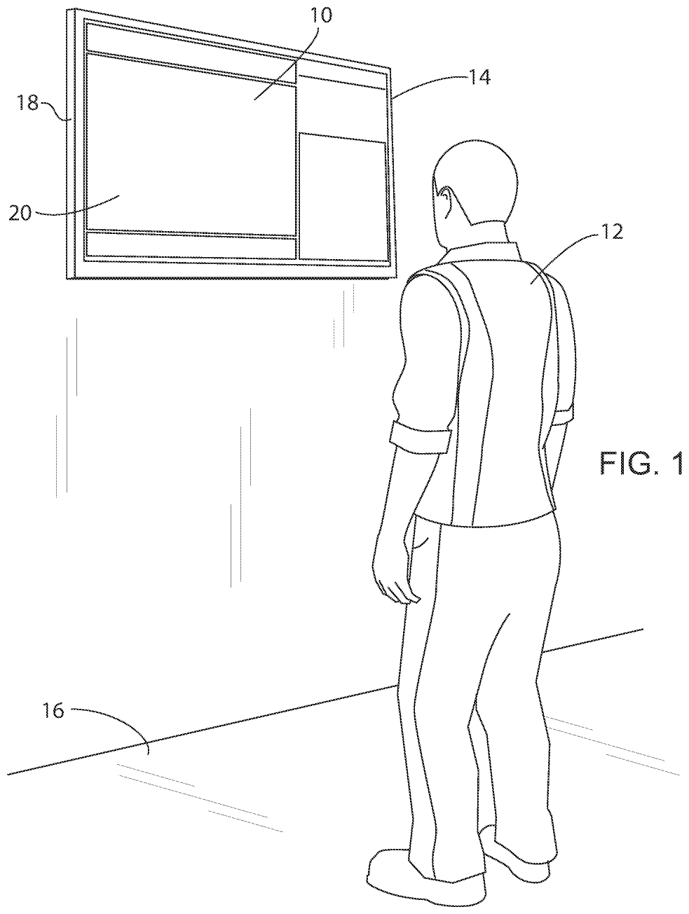

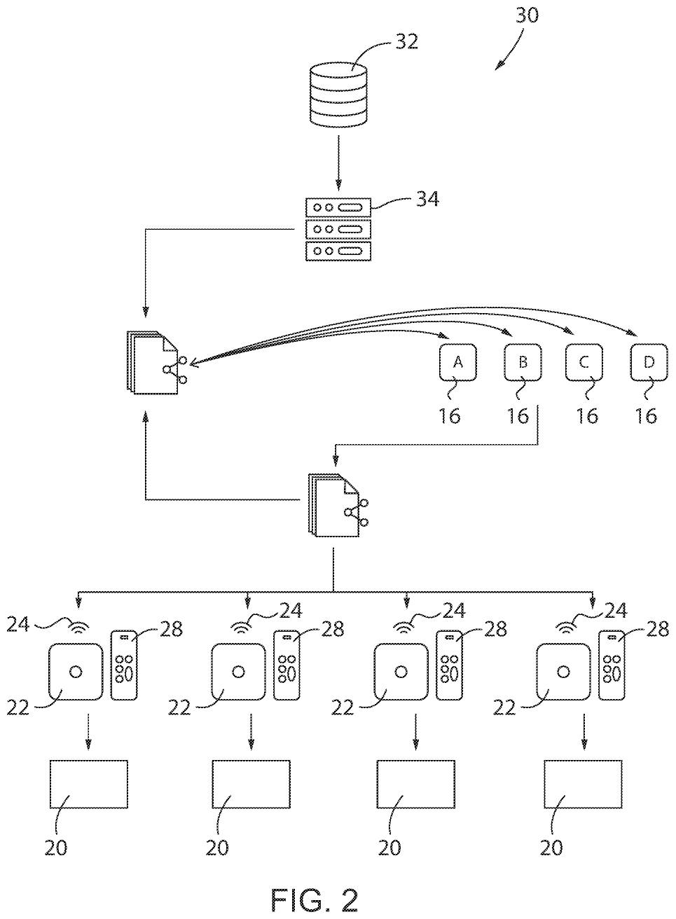

Turning now to FIG. 1, employment law notices and content 10 are electrically presented to employees 12 of an employer on a display device 14 at a specific employer location 16. Similar display devices 14 are provided at other employer locations, if needed, and are not shown in FIG. 1. Preferably, the display device 14 includes digital sign technology such as an electronic poster 18 as is known in the art. The electronic poster 18 preferably includes a display screen 20, a processor 22, a communication system 24 and a power source 26 as is shown in FIG. 2. Other electronic display devices 14 such as televisions, computer screens and the like can also be utilized as is known in the art.

On the display device 14, users such as employers and employees preferably have the ability to swipe through (forward/back/pause) the displayed content for viewing and reading. The users also preferably have the ability to zoom in and out to improve content readability such as for the sight impaired. These capabilities can be delivered such as through the use of a wireless remote-control device 28 that interacts with display device 14. The display device 14 can also have touchscreen capability for ease of use and interaction by the users. The users can also set a language for the content to be displayed in and set a default language for each display device. The minimum functionality of the display device is driven by the applicable employment law rules to ensure compliance. Customer specific announcements and content may also be displayed on the display device.

An employer may have multiple locations where employees will need to view the regulated content on a display device. To determine the required content, the geographic locations of each display device 14 need to be determined. To determine each location, various methods can be used including the use of GPS coordinates, postal zip codes, IP network routing information, or location information obtained when each display device was installed or moved at a given location. Geographic location information of each display device 14 is used to determine the applicable federal, state and/or local employment law posting requirements. Geographic locations can be as State specific, municipality specific or can be another desired category.

Once the geographic locations of each display device 14 is known, the relevant employment law content to be displayed on each display device can be determined, delivered to the respective display device, and as employment law rules change, updated content is determined and delivered in real time automatically. Unnecessary postings are avoided. Seasonal postings, which require posting for only a set period of time or season, can also be accommodated and displayed as required and not displayed when not required.

With reference to FIG. 2, there is shown the hardware architecture 30 of the present invention which provides regulatory compliance to employers in a subscription model by a third party. A content source 32 such as a database is established and updated with the regulatory source content by regulating entity and by geographic location. In the employment law area, the content source 32 preferably contains the employment law regulation for employers such as the posting requirements for federal, state and local entities. The content source 32 is in communication with a content server 34. The content server 34 receives requests from one or more locations that will receive content. In one embodiment, this is a third-party subscription service whereby an employee having locations at A-D subscribes to a service for providing the necessary employment law content to be in compliance will employment law rules. The subscription requests are verified if desired. Relevant content by geographic location is then sent to each display device 14 at locations A-D through any known means such a WIFI connection.

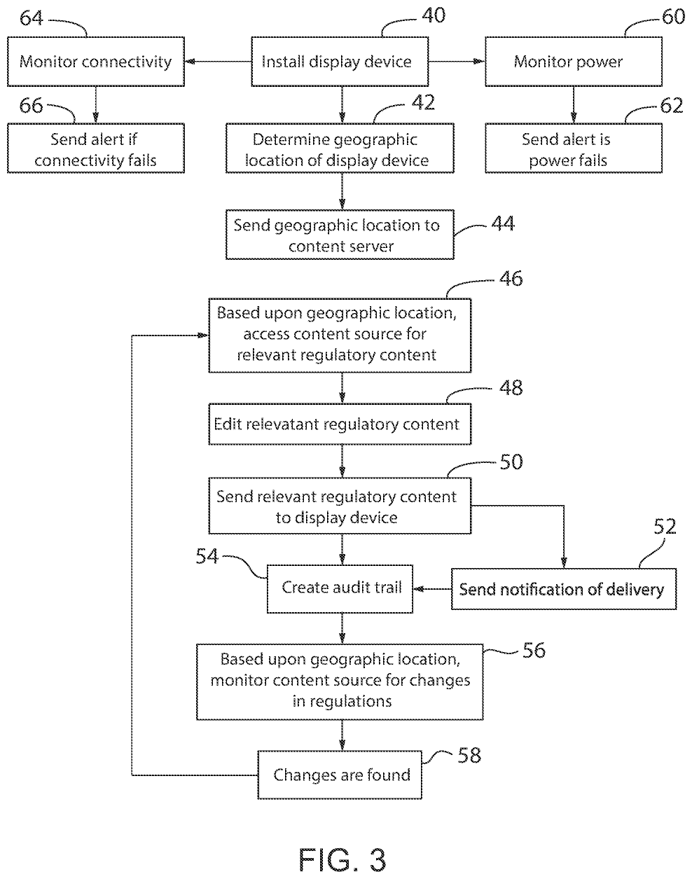

Turning now to FIG. 3, the operation of the invention is shown for one display device 14. However, it should be noted that the process is the same for multiple display devices 14 at the same or different locations. Once the display device 14 is installed at step 40, its geographic location is determined in step 42 as was discussed above. The geographic location is sent to the content server 34 at step 44. Based upon the geographic location, the content source 32 is accessed for relevant regulatory content at step 46 and the accessed relevant regulatory content is edited if necessary or desired at step 48. The relevant regulatory content is then sent to the display device 14 for viewing by employees at step 50. A notification can be sent as needed to alert the employer content has been sent to the display device 14 at step 52. An audit trail or report is created as to what information was sent, to which display device and at what time at step 54. Based upon the geographic location, the content source 32 is monitored for changes in regulations that would affect that display device 14 at step 56. If such changes are found at step 58, the updated relevant content is sent to the display device 14 and another audit trail is created. The display device 14 is monitored for power loss at step 60 and an alert sent if the display device does not have power at step 62. The display device is monitored for communication connectivity at step 64 and an alert sent if the communication connectivity has failed at step 66.

For audit and compliance purposes, an audit trail, report and/or log of all content delivered to each display device 14 is kept and includes a record of the content and time stamp for example. The employer has access to the audit trail and log for each respective display device 14 as evidence if needed to prove compliance with the regulatory compliance rules.

Various features and advantages of the invention are set forth in the following claims.

1. An employment law content determination and delivery method comprising the steps:
for a given geographic location and time, determining appropriate employment law content that is required to be posted to assure employer compliance with employment regulations at the given geographic location and time;
delivering the appropriate employment law content to the employer for electronic viewing by employees of the employer; and
keeping a record of the employment law content that was delivered for a given geographic location and time.

2. The method of claim 1 wherein the given geographic location is state specific.

3. The method of claim 1 where the given geographic location is municipality specific.

4. The method of claim 1 wherein the employment regulations include one of federal, state and local regulations.

5. A method for enabling compliance for an employer of regulatory compliance rules pertaining to where and when regulated content is displayed for consumption by employees of the employer, the method including the steps:
determining at what geographic locations of an employer regulated content needs to be provided to employees of the employer;
determining at what points in time that regulated content needs to be provided to the employees of the employer;
determining what regulated content needs to be provided for electronic viewing by the employees of the employer at each of the geographic locations and at each of the time points; and
delivering the determined regulated content in electronic format to each geographic location and at each time point for consumption by the employees of the employer to ensure the employer is in compliance with regulatory compliance rules at all determined geographic locations and at all times.

6. The method of claim 5 wherein the determined regulated content is displayed on an electronic poster.

7. The method of claim 5 wherein the regulated content includes employment law content.

8. The method of claim 5 wherein the regulatory compliance rules include one of federal, state and local rules.

9. A method for providing employment law content to a display device at a specific geographic location of an employer for viewing by employees to ensure the employer is in compliance with regulatory employment law requirements, the method including the steps:
determining a geographic location of a display device;
matching the geographic location of the display device to relevant employment law content;
delivering the relevant employment law content to the display device for viewing by employees of an employer to make the employer in compliance with regulatory employment law requirements; and
delivering updated employment law content to the display device to ensure that the employer stays in compliance at all times with regulatory employment law requirements.

10. The method of claim 9 and further including the step of recording the time and content of employment law content sent to the display device.

11. The method of claim 9 and further including the step of maintaining the employment law content for viewing by the employees in the event the display devices loses its communication ability.

12. The method of claim 9 and including the further step of notifying the employer upon the completion of each delivery of employment law content.

13. The method of claim 9 and further including the step of monitoring the display device for connectivity status.

14. The method of claim 9 and further including the step of monitoring the display device for power status.

15. The method of claim 9 wherein the regulatory employment law requirements include requirements from at least one of federal, state and local authorities.

16. The method of claim 9 wherein an employee can select a language for the employment law content to be display on the display device.

17. The method of claim 9 and further including the step of the employer selecting a default language for employment law content to be display on the display device.

18. The method of claim 9, wherein the determining step is performed using GPS coordinates.

19. The method of claim 9 and further including the step of editing the relevant employment law content before delivering it to the display device.

20. The method of claim 9 where the display device is an electronic poster.
